(19) United States
(12) Patent Application Publication
(10) Pub. No.: US 2025/0003761 A1
(43) Pub. Date: Jan. 2, 2025

(54) METHOD FOR DISPLAYING ALTERNATIVE NAVIGATION ROUTE, AND NAVIGATION DEVICE

(71) Applicant: Namseok KANG, Seoul (KR)

(72) Inventor: Namseok KANG, Seoul (KR)

(21) Appl. No.: 18/707,658

(22) PCT Filed: Nov. 4, 2022
(86) PCT No.: PCT/KR2022/017281

§ 371 Date: May 6, 2024

(30) Foreign Application Priority Data
Nov. 8, 2021 (KR) 10-2021-0151965

(51) Int. Cl. G01C 21/36

(52) U.S. Cl. CPC G01C 21/3676

(57) ABSTRACT

A navigation device according to an embodiment may include: a user interface for receiving an input from a user and displaying a route; and a control unit controlling the user interface to display the route to a destination input by the user; when an intersection on the route to the destination is selected by the user, determining at least one alternative route that passes through an intersection other than the selected intersection among a plurality of intersections of a road being traveled by a vehicle; and controlling the user interface to display the at least one alternative route. The navigation device suggests at least one alternative route that passes through an intersection other than an intersection selected by a user input, and thus has the effect of expanding the range of routes available for selection by a user.

### TECHNICAL FIELD

The present invention relates to a method and device for displaying alternative navigation routes, and, more specifically, to a technology for a navigation device and a control method that displays various alternative routes to a destination based on the current location, tailored to user preferences.

### BACKGROUND ART

Navigation devices display the current position of a moving body, such as a vehicle, on a map using GPS signals received from the Global Positioning System. These navigation devices are widely used in various moving bodies, including ships, aircraft, and vehicles, to check the current position and moving speed of the body or to determine a travel route.

Generally, navigation devices used in vehicles, upon the user entering a destination, use map information to search for a driving route to the destination and guide the vehicle along the selected driving route. Additionally, the navigation device provides various information visually or audibly, such as the driving route to the destination, nearby geographical features, and road congestion levels, thereby providing a guide to help the user reach the destination.

Recently, navigation devices have begun to suggest alternative routes that can replace the existing route to the destination, and they are capable of displaying comparative data between the existing route and the alternative routes.

However, often the alternative routes are not the routes desired by the user, leading to a low frequency of using these alternative routes, and failing to provide a real alternative to the user.

### DISCLOSURE

### Technical Problem

Therefore, the method and device for displaying alternative navigation routes according to an embodiment are inventions designed to solve the aforementioned problems, with the objective of providing a navigation device that appropriately displays alternative routes tailored to user preferences based on user input.

More specifically, the navigation device and control method according to an embodiment, during the process of navigating to a destination, propose at least one alternative route that does not follow a junction selected by the user but another junction, when there is user input, thus providing a navigation device and control method that can expand the user's choice of routes.

### Technical Solution

In order to achieve the above objects, the present invention provides a navigation device comprising a user interface receiving an input from a user and displaying a route; and a control unit controlling the user interface to display the route to a destination entered by the user, determining at least one alternative route that uses a different junction among multiple junctions on the road where the vehicle is driving when the user selects a junction on the route to the destination, and controlling the user interface to display the at least one alternative route.

The at least one alternative route may include a first alternative route that uses a junction located before the selected junction on the road where the vehicle is driving, and a second alternative route that uses a junction located after the selected junction on the road where the vehicle is driving.

The control unit may control the user interface to display comparison information for each of the at least one alternative route with the existing route.

The comparison information with the existing route may include at least one of the following: information about the increase or decrease in distance compared to the existing route, information about the increase or decrease in time compared to the existing route, or information about the increase or decrease in cost compared to the existing route.

The control unit may control the user interface to display the selected alternative route when a user selects any one of the at least one alternative routes.

The control unit may replace the existing route with the selected alternative route when a user selects any one of the at least one alternative routes.

The method for displaying alternative navigation routes according to an embodiment may comprise: controlling the user interface to display the route to a destination entered by the user; determining at least one alternative route that uses a different junction from multiple junctions on the road where the vehicle is traveling, when the user selects a junction on the route to the destination; and controlling the user interface to display the at least one alternative route.

### Advantageous Effects

According to the navigation device and method for displaying alternative navigation routes of an embodiment of the present invention, multiple alternative routes that use different junctions from the one selected by user input can be provided. This allows users to choose alternative routes that better suit their preferences, thereby expanding the range of alternative route choices. Additionally, the navigation provider can enhance the route navigation algorithm based on data from users' choices of alternative routes.

### BRIEF DESCRIPTION OF DRAWINGS

FIG. 1 is a block diagram showing some components of a navigation device according to an embodiment of the present invention.

FIG. 2 illustrates a navigation device according to an embodiment displaying a route to a destination.

FIG. 3 illustrates a navigation device according to an embodiment displaying a list of alternative routes in response to user input.

FIG. 4 illustrates a navigation device according to an embodiment displaying an alternative route in response to user input.

FIG. 5 illustrates a navigation device according to an embodiment replacing a route with an alternative route in response to user input.

FIG. 6 is a flowchart showing the process of determining an alternative route that uses a junction other than the one selected by the user, according to an embodiment of the navigation device's control method. The present invention

### BEST MODE

The embodiments and configurations depicted in the drawings of the specification are merely exemplary embodiments of the present invention, and various modifications capable of substituting the embodiments and drawings described herein may exist at the time of the present application.

Throughout this specification, when one part is said to be “connected” to another, this includes not only direct connections but also indirect connections, which encompass connections made through wireless networks.

Furthermore, the terminology used in this specification is intended for describing particular embodiments only and not intended to limit the present invention. Unless contextually indicated otherwise, singular expressions include plural expressions. In this specification, terms like “comprise” or “have” indicate the presence of stated features, numbers, steps, operations, components, parts, or combinations thereof, and do not preclude the presence or addition of one or more other features, numbers, steps, operations, components, parts, or their combinations.

Additionally, terms that include ordinal numbers such as “first” and “second” are used to describe various components, but these components are not limited by these terms. These terms are only used to distinguish one component from another. For instance, without departing from the scope of the present invention, a first component may be designated as a second component, and similarly, a second component may also be designated as a first component.

Moreover, terms such as “unit,” “device,” “block,” “member,” “module,” etc., may refer to a unit that processes at least one function or operation. For example, these terms could denote at least one hardware like FPGA (field-programmable gate array)/ASIC (application specific integrated circuit), at least one software stored in memory, or at least one process handled by a processor.

The reference numerals assigned to each step are used for identifying the steps and do not indicate the sequence of the steps; the steps can be performed in an order different from the one described unless explicitly stated otherwise in the context.

Subsequently, detailed descriptions of embodiments regarding the navigation device and its control method according to one aspect will be provided with reference to the accompanying drawings.

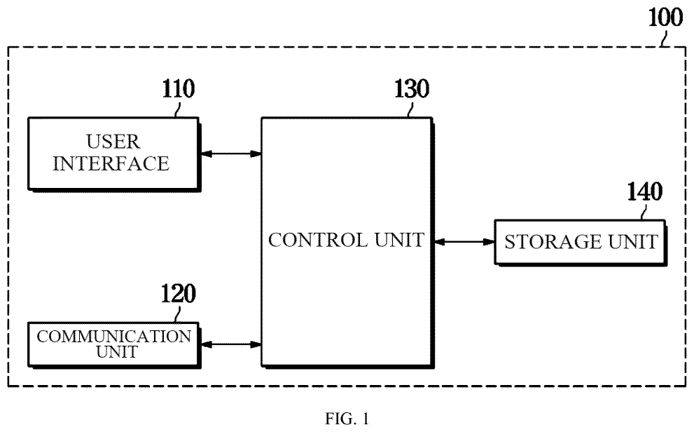

FIG. 1 is a block diagram showing some components of a navigation device according to an embodiment of the present invention.

Referring to FIG. 1, a navigation device 100 according to an embodiment may include a user interface 110 that receives user input and displays routes, a communication unit 120 that receives communication signals (for example, GPS signals), a control unit 130 that determines alternative routes based on user input, and a storage unit 140 that stores various information needed for control.

The user interface 110 according to an embodiment may include an input device capable of receiving user inputs and a display panel capable of showing routes to a destination.

In this case, the input device may be a touch panel integrated with the display panel, according to an embodiment. However, this is not limited, and the input device can be provided as any type of device known in the art.

Furthermore, the display panel can be provided as a type known in the art and can display various information under the control of the control unit 130.

The communication unit 120 according to an embodiment can receive communication signals (for example, GPS signals) from an external device (for example, a satellite), and can be equipped with a communication module known in the art for this purpose.

The control unit 130 according to an embodiment can navigate and determine the route to the destination based on user input entered through the user interface 110 and can control the user interface 110 to display the determined route externally.

At this time, the control unit 130 can determine the current location of the navigation device 100 based on the communication signals received through the communication unit 120, and can determine the route from the current location to the destination based on the navigation settings information stored in the storage unit 140.

Additionally, the control unit 130 can control the user interface 110 to display junctions located on the route to the destination. Here, a junction refers to a point where a branching road diverges from the driving road, and the vehicle can exit the currently traveled road through the junction and enter the branching road. In essence, the junction can act as an exit on the driving road.

The control unit 130, upon receiving a user selection of a junction located on the route to the destination, can determine at least one alternative route that uses a different junction from the multiple junctions on the road where the navigation device 100 is installed and the vehicle is traveling.

In this case, the at least one alternative route may include a first alternative route that uses a junction located before the selected junction on the road where the vehicle is traveling, and a second alternative route that uses a junction located after the selected junction on the road where the vehicle is traveling.

The control unit 130 can control the user interface 110 to display information generated by comparing each of the at least one alternative route with the existing route.

At this time, the comparison information with the existing route may include at least one of the following: information on the increase or decrease in distance compared to the existing route, information on the increase or decrease in time compared to the existing route, or information on the increase or decrease in cost compared to the existing route.

The control unit 130 can control the user interface 110 to display the selected alternative route when a user selects any one of the at least one alternative route.

Additionally, the control unit 130 can replace the existing route with the selected alternative route when a user selects any one of the alternative routes.

The control unit 130 can determine at least one alternative route based on at least one of the following: the shortest distance, the lowest cost, the user's selection history, or the number of selections by other users.

Furthermore, the control unit 130 can determine at least one alternative route that satisfies at least one of the following set by the user: an increase or decrease in distance compared to the existing route, or an increase or decrease in time.

The control unit 130 may include at least one memory storing a program that performs the aforementioned actions and subsequent actions, and at least one processor that executes the stored program. When there are multiple memories and processors, they can be integrated into a single chip or located at physically separated locations.

The storage unit 140 may include well-known information necessary for performing navigation functions, such as map information and navigation settings. Additionally, the storage unit 140 can store the latest version information received from an external server through the communication unit 120, as well as usage records of other users.

Having described the various components of the navigation device 100, further details on how the navigation device 100 determines and displays alternative routes will now be explained.

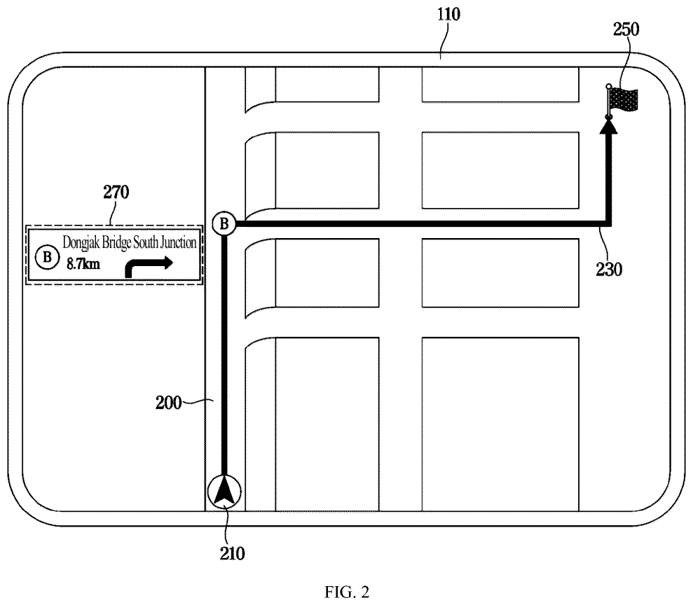

FIG. 2 illustrates an instance where the navigation device 100 displays the route to a destination and multiple junctions according to an embodiment.

Referring to FIG. 2, the navigation device 100 can control the user interface 110 to display the route 230 to a destination 250 and information 270 about junctions on the route 230 to the destination 250. However, according to an embodiment, the display of information 270 about junctions on the route 230 to the destination 250 may be omitted.

The route 230 displayed on the screen can be the route from the current location 210 of the navigation device 100 to the destination 250. For example, the route 230 to the destination 250, as shown in FIG. 2, may correspond to a route exiting via junction B from the driving road 200.

Furthermore, the information 270 about junctions on the route 230 to the destination 250, as illustrated in FIG. 2, may include information about a junction B located on the route to the destination 250, such as the remaining distance and the name of the junction.

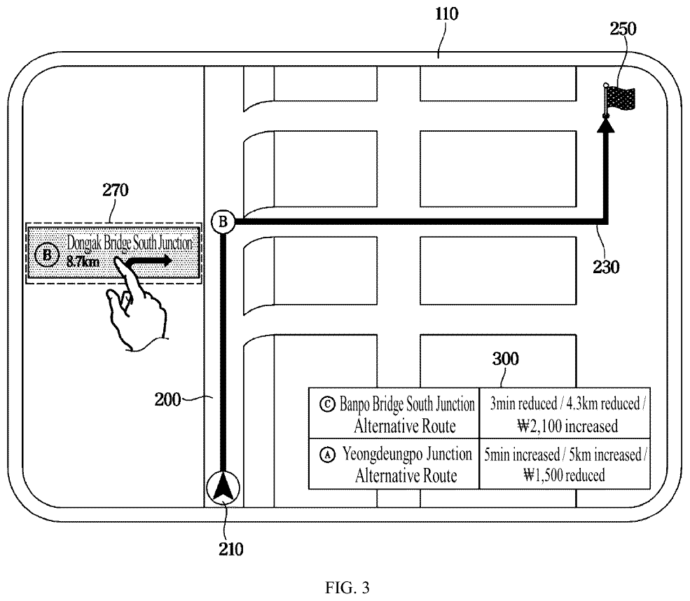

FIG. 3 is a diagram illustrating a case where the navigation device 100 displays a list of alternative routes based on user input according to an embodiment.

Referring to FIG. 3, the navigation device 100 can display alternative routes based on user input.

For example, the navigation device 100, as shown in FIG. 3, can display a list 300 of alternative routes.

Specifically, the navigation device 100 can determine at least one alternative route that uses a different junction (A, C) from the selected junction (B) among multiple junctions (A, B, C) on the driving road 200, when junction (B) on the route 230 to the destination 250 is selected. The navigation device can also control the user interface 110 to display the at least one alternative route.

The alternative routes may include several options, such as a first alternative route that uses a junction (A) located before the selected junction (B) on the driving road 200, and a second alternative route that uses a junction (C) located after the selected junction (B).

For example, if a user selects the Dongjak Bridge South Junction (B), the navigation device 100 can determine a first alternative route that uses the Yeongdeungpo Junction (A) located before the Dongjak Bridge South Junction (B) and a second alternative route that uses the Banpo Bridge South Junction (C) located after the Dongjak Bridge South Junction (B), as illustrated in FIG. 3.

At this time, the navigation device 100 can control the user interface 110 to display comparison information generated by comparing each of the multiple determined alternative routes with the existing route 230. The comparison information may include at least one of the following: information on the increase or decrease in distance, time, or cost compared to the existing route 230.

For instance, as shown in FIG. 3, the navigation device 100 can display comparison information for each alternative route on the list of alternative routes 300, comparing them with the existing route 230.

This allows users, who do not wish to follow the junction guided by the navigation device 100, to see the potential increases or decreases in distance, time, or cost when using different junctions, enabling them to choose the alternative route that best suits their needs. Thus, the navigation device 100, according to an embodiment of the invention, provides information on routes associated with various junctions (A, B, C) located on the driving road 200, allowing users to select alternative routes that suit their preferences and expand their range of route choices.

Additionally, when determining an alternative route that uses a different junction (A, C) from the selected junction (B), the navigation device 100 can determine the alternative route based on at least one of the following: the shortest distance, the lowest cost, the user's selection history, or the frequency of selections by other users.

For example, when determining an alternative route that uses junction (A), the navigation device 100 can decide on an alternative route that results in the shortest distance to the destination 250 while using junction (A), or it can choose an alternative route that minimizes the cost incurred to reach the destination 250 while using junction (A).

Additionally, the navigation device 100 can determine alternative routes based on various criteria. For example, it can choose an alternative route that includes roads used more than a preset number of times by the user with junction (A) as part of the route, or it can include in the route roads that other users have used more than a preset number of times based on usage history received from an external server, or apply trends of increased and decreased usage at the time of navigation to recommend roads to be included in the route.

Furthermore, the navigation device 100 can determine an alternative route that satisfies at least one of the conditions set by the user for an increase or decrease in distance or time compared to the existing route 230.

That is, users can set the range of alternative route choices through the user interface 110 and can set threshold values for increased or decreased distance, as well as for increased or decreased time required compared to the existing route.

In this case, the navigation device 100 can determine an alternative route that has an increase or decrease in distance less than the set threshold value relative to the existing route. Similarly, it can determine an alternative route that has an increase or decrease in time less than the threshold value relative to the existing route.

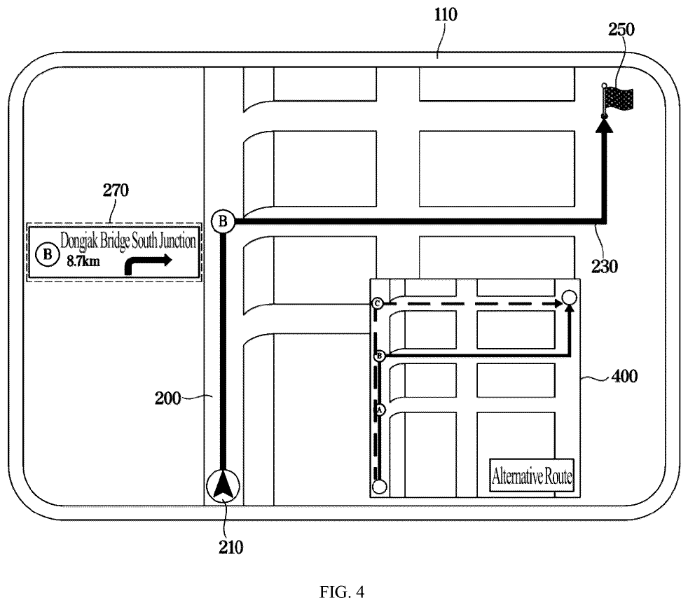

FIG. 4 illustrates a scenario where the navigation device 100 displays an alternative route based on user input according to an embodiment.

Referring to FIG. 4, the navigation device 100 can control the user interface 110 to display the selected alternative route when a user selects one from at least one alternative route during the navigation guidance process.

Users can choose any one of the alternative routes from the list 300, and as shown in FIG. 4, the navigation device 100 can display the screen guiding the alternative route 400 overlaid with the screen guiding the existing route 230. The screen guiding the alternative route 400 can be displayed on the user interface 110 using picture-in-picture (PIP) or navigation-in-picture (NIP) methods. That is, the screen 400 guiding the alternative route can be displayed as a mini-window on the screen guiding the existing route 230.

For example, if a user selects the alternative route that includes Banpo Bridge South Junction (C) as the route, the navigation device 100 can control the user interface 110 to display the screen 400 guiding the alternative route.

This allows users to intuitively recognize the alternative routes and make selection decisions more easily.

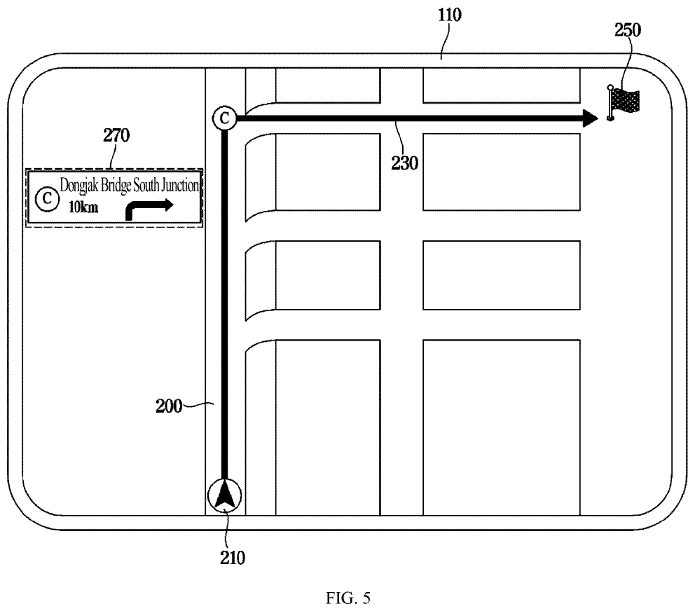

FIG. 5 illustrates a scenario where the navigation device 100 replaces the route 230 with an alternative route based on user input according to an embodiment.

Referring to FIG. 5, the navigation device 100 can replace the existing route with the selected alternative route when a user selects one from at least one alternative route.

For example, if a user selects the alternative route that includes the Banpo Bridge South Junction (C) as the route, the navigation device 100 can replace the route to the destination 250 with the alternative route including Banpo Bridge South Junction (C) and display it.

This allows the navigation device 100 to guide to the destination 250 using the alternative route based on user selection, and users can travel to the destination 250 via the alternative route.

It should be noted that the description has simplified the presentation by assuming that there are three junctions on the driving road 200, but the present invention is not limited to this, and the number of junctions that the navigation device 100 can guide is not restricted. In other words, the navigation device 100 can determine one or more alternative junctions other than the junction selected by the user and guide alternative routes for each determined junction.

Subsequently, examples of the control method for the navigation device 100 according to one aspect will be discussed. The control method for the navigation device 100 can use the same navigation device 100 as described in the previous examples. Therefore, the descriptions provided in FIGS. 1 to 5 can also be applied identically to the control method for the navigation device 100.

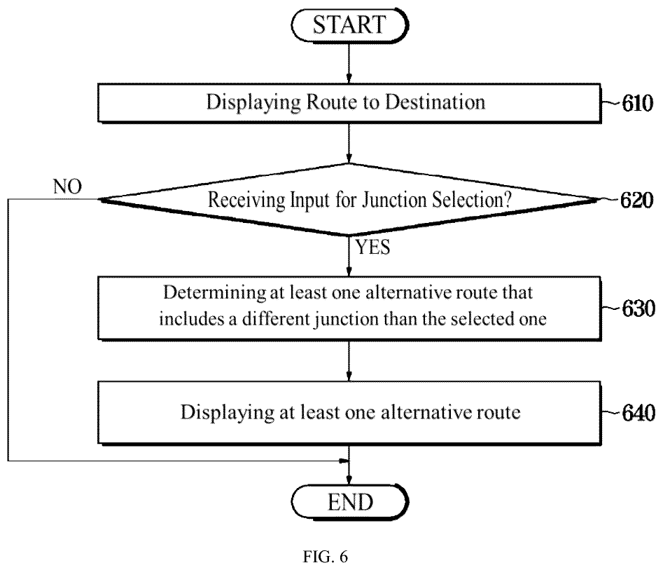

FIG. 6 is a flowchart illustrating a process of determining an alternative route that includes junctions other than the one selected by the user according to an embodiment of the navigation device 100.

Referring to FIG. 6, the navigation device 100 can display the route 230 to the destination 250 (610).

When the navigation device 100 receives input for junction selection (example at 620), it can determine at least one alternative route that includes a different junction than the selected one (630), and it can display at least one alternative route (640).

Specifically, if a user selects junction B on the route 230 to the destination 250, the navigation device 100 can determine at least one alternative route that includes different junctions (A, C) from the selected junction B among multiple junctions (A, B, C) on the driving road 200, and can control the user interface 110 to display at least one alternative route.

In this scenario, at least one alternative route may include a first alternative route that uses junction A located before the selected junction B on the driving road 200, and a second alternative route that uses junction C located after the selected junction B.

At this time, the navigation device 100 can control the user interface 110 to display comparison information for each alternative route with the existing route 230. The comparison information may include at least one of the following: information on the increase or decrease in distance, time, or cost compared to the existing route 230.

This allows users, who do not wish to follow the junction guided by the navigation device 100, to see the potential increases or decreases in distance, time, or cost when using different junctions, enabling them to choose the alternative route that best suits their needs. Thus, the navigation device 100, by providing information on routes associated with various junctions (A, B, C) located on the driving road 200, can expand users' range of route choices.

Detailed explanation have been provided on the navigation device and its control method according to an embodiment of the present invention, as illustrated in the accompanying drawings.

According to an embodiment of the present invention regarding the navigation alternative route display method and device, it is possible to provide multiple alternative routes that use different junctions than the one selected by user input. This allows users to choose alternative routes that better suit their preferences, thereby enhancing the utility of the navigation device.

Meanwhile, the disclosed embodiments are described in terms of devices that store computer-executable instructions, which can be implemented as hardware components, software components, or a combination of hardware and software components. For instance, the devices and components described in the embodiments can be implemented using one or more general-purpose computers or special-purpose computers, such as processors, controllers, ALUs (arithmetic logic units), digital signal processors, microcomputers, FPAs (field-programmable arrays), PLUS (programmable logic units), microprocessors, or any other devices capable of executing and responding to instructions. The processing device can perform one or more software applications running on an operating system (OS) and can also access, store, manipulate, process, and generate data in response to the execution of software. For convenience of understanding, it is described that one processing device is used, but those skilled in the relevant field will understand that the processing device can include multiple processing elements and/or multiple types of processing elements. For example, the processing device may include multiple processors or one processor and one controller. Other processing configurations, such as parallel processors, are also possible.

Software may include a computer program, code, instruction, or a combination thereof, which may configure the processing device to operate as desired or command the processing device independently or collectively. Software and/or data can be embodied in any type of machine, component, physical device, virtual equipment, computer storage medium, or device to provide instructions or data to the processing device. Software and data can be distributed across a computer system connected via a network, stored or executed in a distributed manner. Software and data can be stored on one or more computer-readable recording media.

As such, although the embodiments have been described through limited examples and drawings, various modifications and variations can be made by those skilled in the art based on the descriptions herein. For example, the described technologies can be performed in a different order from the described methods, and/or the described systems, structures, devices, circuits, and other components can be combined or arranged in different forms from the described methods, or replaced or substituted by other components or equivalents. Therefore, other implementations, other embodiments, and equivalents to the claims are within the scope of the following claims.

What is claimed is:

1. A navigation device comprising:
a user interface receiving an input from a user and displaying a route; and
a control unit controlling the user interface to display a route to a destination based on the input from the user, determining at least one alternative route using a different junction from the selected junction among multiple junctions on a road traveled by a vehicle when the user selects a junction on the route to the destination, and controlling the user interface to display the at least one alternative route,
wherein the at least one alternative route comprises:
a first alternative route using a junction located before the selected junction on the road traveled by the vehicle, and
a second alternative route using a junction located after the selected junction on the road traveled by the vehicle.

2. The navigation device of claim 1, wherein the control unit controls the user interface to display comparison information for each of the at least one alternative route with the existing route.

3. The navigation device of claim 2, wherein the comparison information comprises at least one of information on the increase or decrease in distance compared to the existing route, information on the increase or decrease in time compared to the existing route, and information on the increase or decrease in cost compared to the existing route.

4. The navigation device of claim 1, wherein the control unit controls the user interface to display the selected alternative route when the user selects any one of the at least one alternative route.

5. The navigation device of claim 1, wherein the control unit replaces the existing route with the selected alternative route when the user selects any one of the at least one alternative route.

6. A method of controlling a navigation device comprising a user interface, the method comprising:
controlling the user interface to display a route to a destination based on an input from a user;
determining at least one alternative route using a different junction from the selected junction among multiple junctions on a road traveled by a vehicle when the user selects a junction on the route to the destination; and
controlling the user interface to display the at least one alternative route,
wherein the at least one alternative route includes:
a first alternative route using a junction located before the selected junction on the road traveled by the vehicle, and
a second alternative route using a junction located after the selected junction on the road traveled by the vehicle.
